(19) United States
(12) Patent Application Publication
(10) Pub. No.: US 2026/0288652 A1
(43) Pub. Date: Sep. 24, 2026

(54) USER-DEFINED OBJECT MEMORY SEGMENTATION AND OBJECT ELEMENT COMPRESSION

(71) Applicant: Zoho Corporation Private Limited, Kanchipuram District (IN)

(72) Inventors: Sridhar Vembu, Tenkasi (IN); Akshhayaa S, Guduvanchery (IN)

(73) Assignee: Zoho Corporation Private Limited, Kanchipuram District (IN)

(21) Appl. No.: 19/540,732

(22) Filed: Feb. 15, 2026

Related U.S. Application Data
(60) Provisional application No. 63/803,037, filed on May 9, 2025.
(60) Provisional application No. 63/841,856, filed on Jul. 10, 2025.
(60) Provisional application No. 63/915,041, filed on Nov. 10, 2025.

(30) Foreign Application Priority Data
Mar. 24, 2025 (IN) 202541027394
May 29, 2025 (IN) 202541051803
Sep. 10, 2025 (IN) 202541086105

(51) Int. Cl. G06F 12/109

(52) U.S. Cl. CPC G06F 12/109

(57) ABSTRACT

Embodiments are disclosed for compiling source code to instantiate objects with identified elements, developer-identified or compiler-identified via code analysis, stored in a first memory location independently from the remainder stored in a second location. Frequently used elements stored separately increase likelihood of remaining in cache. Identified elements may be packed together in one or more machine words and optionally shortened, compressed, truncated or otherwise transformed. Developer-supplied modifications to an identifier construct direct the compiler how an identified element is to be stored such as number or range of bits, size, location. When unspecified, the compiler may determine various parameters, resolve any conflicts, and otherwise optimize packing. The compiler auto-generates instructions to instantiate the objects, as segregated, in memory at runtime and to access identified or remainder elements appropriately in response to a request. In each embodiment, object memory segmentation and compression is performed at runtime automatically and accurately without programmer intervention other than guidance provided via identifier constructs.

### CROSS REFERENCE TO RELATED APPLICATIONS

This application is related to Indian Provisional Application 202541051803 filed 29 May 2025 and U.S. Patent Application Ser. No. 63/841,856 filed 10 Jul. 2025, both entitled “FREQUENTLY USED DATA BIT ALLOCATION BY PROGRAMMER”, and both of which are incorporated herein by reference.

This application is also related to Indian Provisional Application 202541027394 filed 24 Mar. 2025 and U.S. Patent Application Ser. No. 63/803,037 filed 9 May 2025 (hereinafter the '037 application), both entitled “COMPILER-AUTOMATED COLLECTION ELEMENT ADDRESS COMPRESSION AND ACCESS”, and both of which are incorporated herein by reference.

This application is also related to Indian Provisional Application 202541086105 filed 10 Sep. 2025 and U.S. Patent Application Ser. No. 63/915,041 filed 10 Nov. 2025, both entitled “USER-DEFINED OBJECT MEMORY SEGMENTATION AND OBJECT ELEMENT COMPRESSION”, and both of which are incorporated herein by reference.

This application is also related to Indian Application 202541027394 filed 19 Jan. 2026 and U.S. patent application Ser. No. 19/460,083 filed 26 Jan. 2026, both entitled “COMPILER-AUTOMATED COLLECTION ELEMENT ADDRESS COMPRESSION AND ACCESS”, and both of which are incorporated herein by reference.

### FIELD OF THE INVENTION

Embodiments of the present disclosure are related, in general, to computer programming languages and more particularly, but not exclusively, to memory management.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1A is a computational device 100 which comprises a compiler to perform user-directed automated object memory segmentation and object element compression.

FIG. 1B illustrates executable code 160 loaded into a memory 150 to perform object memory segmentation and object element compression at runtime.

FIG. 2 is a flowchart 200 illustrating an example method of compiling source code for segregated-element object memory segmentation.

FIG. 3 is a flowchart 300 illustrating an example method of compiling source code using segregated-element object memory segmentation and element compression.

FIGS. 4A-B include flowcharts 400 and 420 illustrating segregated-element object memory segmentation and element compression operating at runtime.

FIG. 5 is an example compiler 130 illustrating Object Memory Segmentation and Compression (OMS&C) processing phase 120.

FIG. 6 illustrates an example embodiment of distributed Integrated Development Environment (IDE) 600 including components of a computational device 100.

### DETAILED DESCRIPTION

In modern computing systems, memory efficiency is a critical consideration, particularly in environments where resources are limited, such as embedded systems, mobile devices, and systems with constrained hardware. Even in relatively unconstrained systems, which may include large memory, multiple processor cores, and multiple cache levels for each, performance is generally enhanced when processor-intensive tasks can be performed while utilizing the fastest cache, typically the smallest, with as few cache misses as possible.

Methods, systems, and non-transitory computer-readable media are disclosed for various embodiments enabling compiling source code to generate executable code for instantiating objects in memory at runtime with a first set of the object's elements stored in a first memory location independently from the remainder of the object's elements stored in one or more second memory locations. The compiler identifies the first set of elements by examining the source code.

A developer may identify an element to be included in the first set by including one or more identifier constructs in the source code identifying one or more elements for storing independently. The compiler may also evaluate the source code to determine elements to store independently based on their usage.

The elements may be identified for storing separately for any purpose. These elements can be selected from any of the object elements and stored in any order in the independent memory location. One advantageous strategy is to identify frequently used elements. When they are stored separately from less frequently used elements, there can be an increased likelihood that those elements remain in a cache longer, reducing cache misses. Furthermore, non-identified elements, being stored independently in one or more second locations will not automatically be loaded into cache along with an access to an identified element. When an access is made to a first element, perhaps a frequently used element, where the object elements are stored conventionally, a neighbor element may be fetched along with the frequently used element, the neighbor element perhaps infrequently or never used. This can reduce the utilization of the cache and overall performance. By segregating a first set of object elements in memory from the remainder of object elements, it is possible to achieve higher cache utilization and performance.

Elements identified for storing independently may also be packed together in one or more machine words. One or more of the elements may be shortened, compressed, truncated or otherwise transformed in order to fit more elements into the machine words. An element may also be stored in its original form, along with or in addition to the packed elements.

A developer can utilize one or more modifications to an identifier construct to direct the compiler in the manner in which an identified element or elements is to be stored. A modifier may be applied to the identifier construct, to one or more of the elements associated with the identifier construct, or both. A modifier may identify the number of bits of an element that should be stored, which may be a smaller number than the element as defined. For example, consider an element for storing a person's age. If age is defined as an integer, it may be, e.g., 16, 32, or 64 bits. Yet 7 bits are plenty to cover any person up to age 127. Children's ages can fit comfortably in 5 bits, and younger children still may fit within 4 or 3. A developer is empowered to both identify such an element for independent storing, as well as truncating the element from its defined size. This technique may be used on additional one or more identified elements to compress elements into one or more machine words. A modification may not specify a bit width, signaling the compiler to determine the appropriate bit width.

A modifier may specify a range in which the element should be stored. This range can indicate the bit width as well as location. A single location in the range identifies a single bit, useful for, e.g., storing Boolean elements. A modification may not identify a location, signaling that the compiler is to determine the location for storing the identified element. The compiler may use the width of the object element as defined, or determine an alternate smaller width based on the use of the element in context in the source code. A modifier may specify a range less than the defined size of an element, indicating the compiler is to generate instructions to store the element in fewer bits than its defined size and to appropriately scale the element when accessed. In another embodiment the modifier may also indicate which bits need to be stored in the specified location range.

The compiler may identify an element for inclusion into the set of identified elements based on its use within source code, whether or not the developer has signaled inclusion by using an identifier construct. The compiler can determine whether there are any packing conflicts based on modified identifier constructs supplied, in which a position within the one or more machine words is indicated to store an element or portion thereof of more than one element. The compiler may generate a compile time message in this case or alternately reorder one or more of the identified elements to remove the conflict. The compiler may perform an analysis and reordering of identified elements to reduce the number of machine words required to store the identified elements. The compiler may also select one or more additional elements for inclusion in the set of identified elements to include in one or more unallocated positions within the machine words, whether or not the element was identified by an identifier construct or otherwise selected by compiler analysis of the code.

Segregating identified elements and storing them in a first memory location separately from the remainder of an object's elements stored in one or more second memory locations, as described above, may enhance performance in an embodiment. Compressing, or packing, one or more of the identified elements for an object into a set of machine words in the first memory location may be combined with the segregation in an embodiment. In yet another embodiment, the compiler generates instructions to store the identified elements, whether or not compressed, for each of a plurality of instantiated objects in the memory, sequentially from the first memory location (or otherwise generally located nearby). Co-locating the identified elements for multiple objects in memory is an aspect allowing processes working on the multiple objects to enjoy an increased likelihood of those elements remaining in the cache during operation. Optional instructions to prefetch into a cache identified elements for one or more of the multiple objects may be generated.

Techniques for compiling source code and generating instructions for runtime packing and retrieving packed memory elements in the context of compressing offset memory pointers are disclosed in the aforementioned '037 application. One or more of those techniques may be adapted for implementation of an embodiment for object memory segmentation and compression, as necessary. Because there can be processing overhead to store an update to a packed element or to retrieve and isolate a packed element, the developer utilizing an identifier construct appropriately modified, or a compiler during its analysis phase, may determine to forego compression or packing on any of one or more identified elements when it is deemed optimal to do so.

In an alternate embodiment, identifier constructs identifying one or more elements for storing independently, along with any modifications, may be stored in a file other than a source code file, such as a configuration file. Identifiers may also be stored in both source code and one or more configuration files. The source code and/or configuration files, compilable by a compiler and executable by a processor coupled with a memory, may be stored on a non-transitory computer-readable medium, or multiple such media.

The compiler auto-generates instructions to modify any conventional instructions to instantiate the objects in memory and any supporting structure at runtime, as necessary. For example, instructions to set up the first memory location for an object or plurality of objects and any supporting variables or structures are generated. Responsive to encountering a create statement for an object of the type, instructions are generated to store the identified elements of that object in the first memory location, and to store the remainder of the elements in one or more second memory locations. The compiler may perform a related process for object deletion, where, for example, the remainder elements of the object and associated structure are deleted conventionally, and additional instructions are generated to remove the identified elements from the first memory location.

Responsive to encountering access instructions to an object, the compiler auto-generates additional instructions or modifications to conventional access instructions. For example, access requests such as a request to fetch an element or to update an element in memory will be analyzed. Access requests to the identified elements will have instructions generated to retrieve those elements from the first memory location, while requests to the remainder elements can be compiled to use conventional access techniques from the second memory locations. When an identified element is packed, instructions are generated to retrieve the appropriate machine word in which the element is packed, and to isolate the element from the other packed elements for use by the access instruction.

Suitable modifications to those access instructions may be made by the compiler as necessary. Embodiments are disclosed for auto-generating and/or injecting these instructions during compile time at one or more phases of compilation. In each embodiment, with the resultant executable code, object memory segmentation and compression is performed at runtime automatically and accurately without intervention in source code by a programmer, other than providing guidance via the identifier constructs and their modifications.

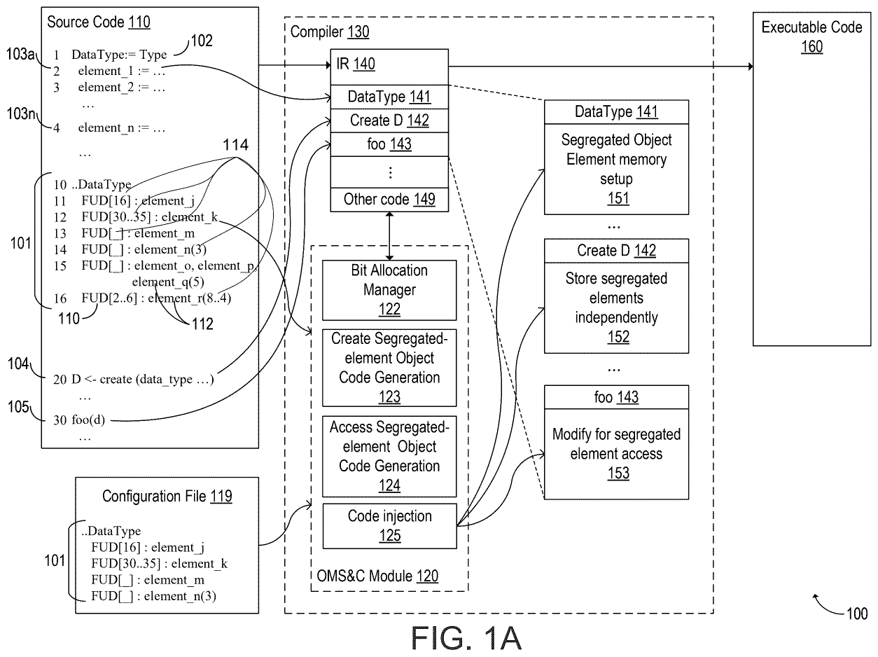

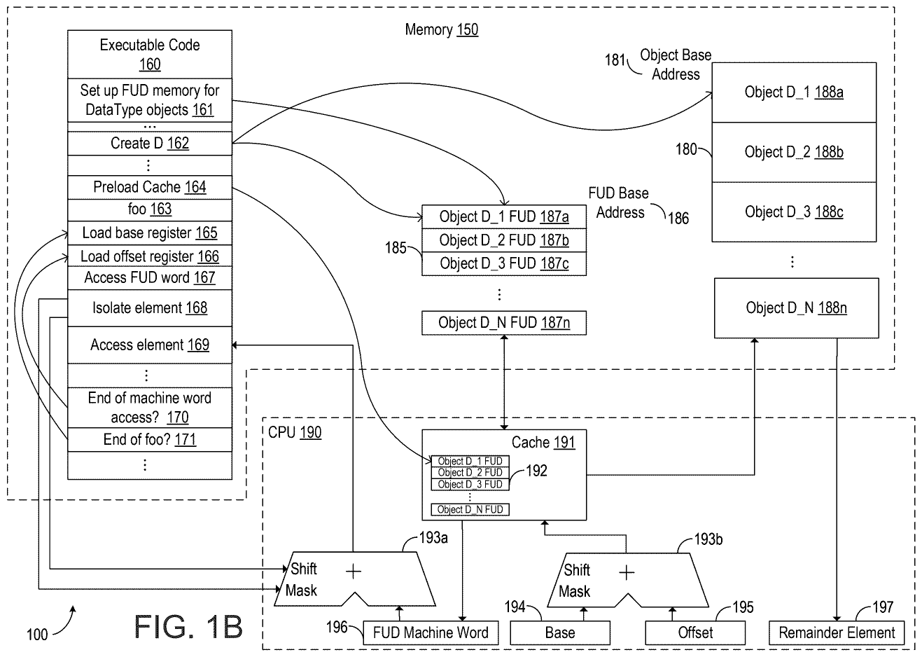

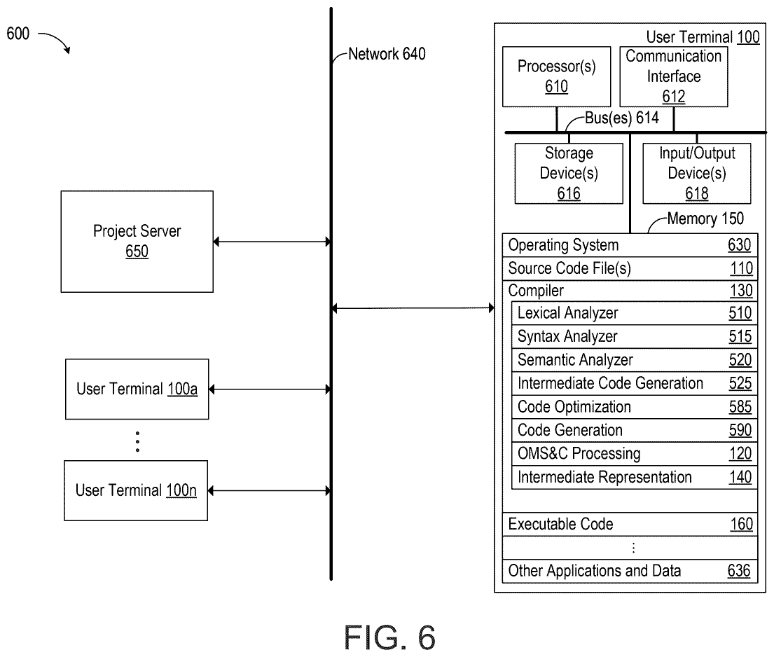

FIG. 1A depicts an example embodiment of a computational device 100, such as a computer or user terminal, detailed further below with respect to FIG. 6, which comprises a compiler 130 operable with an Intermediate Representation (IR) 140 of source code 110 to generate instructions to perform user-directed object memory segregation and compression for one or more objects. IR 140 can be further compiled to produce executable code 160. FIG. 1B illustrates executable code 160 loaded into a memory 150 of computational device 100 to perform object memory segregation and compression with Central Processing Unit (CPU) 190 at runtime.

In FIG. 1A, Source code 110 comprises an illustrative type definition 102 defining n elements, element_1, element_2, . . . , element_n(103a-n), of type DataType (lines 1-4). Lines 10-16 illustrate a selection of developer-supplied identifier constructs 101 identifying various elements of type DataType for object memory segregation. Line 20 is an illustrative create instruction 104 for creating an instantiation of an object D of type DataType. In the illustrative source code, “:=” denotes a type or element declaration and “:” denotes element or type usage. The use of pascal case (PascalCase) for type and element identifiers indicates a declaration and the use of snake case (snake_case) represents type and element usage. The delimiter “--” identifies comments. Line 30 is an illustrative function foo(d) 105, operating on DataType object D, which illustrates accesses to DataType objects (accesses can include reads and writes to object elements, details not shown).

Identifier constructs 101 are defined with a keyword 110, “FUD” in this embodiment, and include one or more identified elements 112. In an alternate embodiment, “frequently_used_bit” can be used as an identifier construct keyword. In a given embodiment, any keyword may be employed that is sufficiently distinguishable from other source code elements. Each identifier construct 101 may be modified by one or more modifiers 114. A modifier 114 may modify the keyword 110 or the identified element 112. In this example, square brackets are used as a modifier to the keyword 110 and parentheses are used as a modifier to an element. Alternate modifiers may be employed.

FUD[16] in line 11 indicates a single bit is to be stored for element_j in the 16th bit in the machine word. FUD[30 . . . 35] in line 12 indicates 6 bits of element_k is to be stored in the bit range 30 . . . 35 in the machine word. Square brackets surrounding an underscore modifying FUD in line 13 indicate the compiler is to determine the location of element_m within the machine word. Since there is no modifier associated with element_m, the compiler is to determine the number of bits to use. This may be selected as the number of bits of element_m as defined, or the compiler may determine the size based on usage of the element and its context. Square brackets with underscore are optional. Alternate embodiments may omit them. Line 14 illustrates square brackets with underscore modifying FUD again, so the compiler is to determine the location. Here, the modifier 114 is (3), which signifies the bit width to store element_n is 3. This example assumes an integer in an element modifier is a bit width. An alternate embodiment, detailed below, specifies the parameter within the modifier. For example, element_n(bitwidth:3) may be used. This syntax allows additional parameters to be specified in the modifier. A default for an integer or a range may be employed along with specific parameter indicators in an embodiment. Multiple elements may be included with an identifier construct keyword 110, as shown in line 15. Here, the three elements element_o, element_p, and element_q are identified, to be stored in locations determined by the compiler as indicated by the square brackets. The first two have no size modification, so the bit width of each is also left to the compiler to determine. The third, element_q, has modifier (5) indicating it should be stored in 5 bits. Line 16 illustrates an identifier construct with a bit range 2 . . . 6 in the modification, indicating where in the machine word element_r is to be stored. Here, the modifier 114 (8 . . . 4) to the element indicates the number of bits to be stored, which matches the range on the first modifier. However, this range indicates that the least significant bits 3 . . . 0 should be truncated. In this scenario, the compiler will generate instructions to scale element_r back to its original position upon retrieval from memory, albeit without the precision of the least significant bits.

These examples illustrate locations within a single 64-bit machine word. If additional machine words are utilized, then locations within additional machine words may be identified sequentially. Alternately a syntax identifying a machine word and location within it may be employed. Various other user-defined indicators may be employed in modifying identifier constructs for segregating and/or packing object elements. Various alternative syntax schemes may be used. Configuration file 119 is shown also having a set of identifier constructs 101. In various embodiments, identifier constructs 101 may be incorporated in source code 110, in one or more files, or in one or more configuration files 119, or any combination. The embodiments illustrated below will refer to identifier constructs being located in source code for brevity, but it will be understood by those of skill in the art that alternate identification and modification schemes may be employed in performing object memory segmentation and compression.

Compiler 130 generates intermediate representation (IR) 140 from source code 110. Object Memory Segregation and Compression (OMS&C) module 120 operates on IR 140, which can be any type of IR. Compiler 130 can operate on source code directly in an alternate embodiment. It identifies one or more identifier constructs 101 in source code, the presence of which will signify that segmentation is enabled for objects of the data type associated with each identifier construct 101. In alternate embodiments, the compiler may be designed to look for data types for automatically segmenting in addition to or instead of user-defined direction to segment and/or compress. The code injection module 125 generates and/or modifies code to implement required structures and instructions instantiation of and access to segmented objects at runtime. In one embodiment, those instructions are introduced into IR 140. Any number of additional compiling phases may be performed on IR 140. Ultimately the compiler generates executable code 160.

The compiler generates IR 140 from source code 110. Illustrated are IR representations derived from various statements and instructions in the source code. DataType 141 defines the type for objects of type DataType. Create D 142 are instructions to instantiate an object D of type DataType. The function foo 143 is an illustrative function that will access, reads and/or writes, elements in DataType objects. The rest of source code 110 is represented as IR other code 149.

Responsive to the presence of identifier constructs 101 in source code, OMS&C module 120 will perform functions to modify IR 140 to prepare it to compile to executable 160 supporting object memory segmentation. FIG. 1A illustrates this trigger from source code, although in the example embodiment identifier constructs 101 will be identified within IR 140 responsive to their presence in the source code.

Bit allocation manager 122 processes the identifier constructs 101 and their modifications. It identifies widths and locations for storing elements as directed. It locates positions for elements when they are not specified. It determines widths for storing elements when they are not specified. If there are conflicting directives, where more than one element bit is directed to be stored in a position in a machine word, it generates a compile time message in one embodiment or relocates one or more elements to resolve any conflicts in another. It can analyze the identified elements 112, as modified by modifiers 114, to determine the number of machine words required for each object's first memory location. It can optimize the element locations to optimize the first memory location to utilize the fewest number of machine words per instantiated object. This process is repeated for as many type definitions for which one or more identifier constructs 101 are present in the source code (or alternate mechanisms to direct the compiler to identify elements for memory segregation for an object).

Create segregated-element object code generation module 123 generates code to set up memory for types using memory segmentation and to instantiate one or more of those objects of those types at runtime. The code will cause memory to be allocated for the first and one or more second memory locations for each instantiated object. It will modify instructions and create additional instructions, as necessary, to instantiate objects with their respective elements located in the proper first or second memory locations.

Access segregated-element code generation module 124 identifies instructions throughout IR 140 that access elements of an object of a type for which segmentation is enabled. It determines when an access is made to an identified element and generates instructions to access that element from the first memory location. It utilizes the locations and widths for each identified element, as determined in the bit allocation manager 122, and generates instructions required to isolate an element, using masks and shifts as appropriate. Note again that elements may be stored in the first memory location without packing and the resultant need to insert instructions to isolate the element. Accesses to non-identified elements are made to and from the second memory locations conventionally. This module handles these situations automatically.

Code injection module 125 injects the generated code into IR 140 (or other format in alternative embodiments). In this example, code from the create segregated-element object code generation module 123 is injected in three places. First, segregated object element memory setup instructions 151 are inserted (and may also modify) instructions associated with DataType 141. These instructions compile to runtime instructions for setting up memory for the segregated objects, objects of type DataType in this example. Second, Create D 142 instructions are modified or augmented with instructions to store the segmented elements independently 152. As a result of analysis during the access segregated-element code generation module 124, foo 143 has instructions 153 to modify accesses within foo for segregated-element object access to the elements, based on whether they are stored in the first or second memory locations.

FIG. 1B depicts IR 140 having been compiled into executable code 160 and loaded into a memory 150 for runtime execution. Shown operating on the instructions in executable code 160 is a portion of a Central Processing Unit (CPU) 190, an example of a processor 610 (detailed below with respect to FIG. 6). Embodiments illustrated below may refer to a 64-bit architecture for registers and memory word-widths. Those of skill in the art will readily adapt the principles detailed herein to any architecture size.

Instructions 161 are compiled from IR 140 instructions 151. They set up memory for instantiating an object. Here memory is allocated for the first memory location 185 in which the identified elements for segregation of each object will be stored upon instantiation. In this embodiment, the first memory location stores identified elements of each of a series of objects sequentially starting at a first memory base address, FUD base address 186. Memory is also allocated for one or more second memory locations 180 in which the remainder of elements from each object will be stored upon instantiation. In this embodiment, the second memory location for remainder elements of each of the series of objects are also stored sequentially starting at a second memory base address, Object base address 181. This is convenient when objects are equal sized so that they can be accessed with a simple object pointer added to an object index multiplied by the object size, modified as necessary to select any particular element. It is also useful when an element lookup table is stored for the remainder of object elements, with pointers to element locations which can be stored anywhere in memory and allow any of the elements to be of any arbitrary size. Any scheme of second memory locations for a set of objects may be employed in a given embodiment.

Instructions Create D 162 are compiled from the Create D 142 instructions as augmented and/or modified by IR instructions 152. They instantiate an object D of type DataType, storing identified elements separately in memory location 185 and the remainder elements in second memory location 180. In this example, the create instructions have been repeated to produce N DataType objects with Object D_1 FUD-Object D_N FUD (187a-n), the identified elements for segregation of the N objects stored in the first memory location 185 sequentially from FUD base address 186. The remainder elements, Object D_1-Object D_N (188a-n), of each object are stored in one or more second memory locations. In this example, they are stored sequentially from object base address 181.

The instructions for foo 163 are compiled from foo 143 and have been modified to account for segregation and any packing that was specified, either by user direction with identifier constructs or by the compiler. In this example, foo 163 instructions are shown to illustrate accessing elements from various DataType objects D. The details of the hypothetical computations that foo performs are omitted.

When executable code 160 is finalized, the available hardware in CPU 190 will have been considered during compilation to optimize performance. In this example, a general Arithmetic Logic Unit (ALU) 193 is available, which among other functions, allows for a simultaneous shift operation and a mask operation (bitwise AND in this example) to an input. The inputs (as shifted or masked) can also be summed. A number of registers are available. They will be referred to by their function in this example but are typically available as general-purpose registers. Offset register 195 is loaded with a value comprising an index, which can be a pre-compiled constant, or a variable generated in accordance with code emitted by the compiler. In this simple example, pre-compiled constants are used. A base value is loaded in base register 194. In this example, to access first memory location 185, FUD base address 186 is loaded into base register 194. To access an object in a second memory location 180, Object base address 181 is loaded into base register 194.

Embodiments detailed herein can be adapted to virtually any CPU and its corresponding ALUs, including those custom-made or standardly available. A wide variety of memory access instructions, register configurations, and ALU operations may be found in any CPU. It is an inherent aspect of a modern compiler to generate target executable code for a CPU that takes advantage of available components and design, which is tailored for each application compiled and target architecture, and which the techniques detailed herein for automated data structure element address compression and access are well suited. Common architectures include the x86-64 architecture (Intel/AMD) and the ARM64 architecture. Details for available instructions, registers, and memory access protocols useful for automated pointer-compression can be found in these references:
Intel 64 and IA-32 Architectures Software Developer's Manual, Vol. 1-3, Intel Corporation, 2021. Available:
www.intel.com/content/www/us/en/developer/articles/technical/intel-sdm.html
AMD64 Architecture Programmer's Manual, Vol. 1-5, Advanced Micro Devices, 2017. Available: www.amd.com/en/support/tech-docs
ARM Architecture Reference Manual, ARMv8-A for ARMv8-A architecture profile, ARM Ltd., 2020. Available: developer.arm.com/documentation/ddi0487/latest/

Returning to function foo 163, an access to an object element is required. During compilation, the instructions 153 generated to modify access instructions for segregated-element object access compile to differing access instructions based on whether the first memory location with identified elements is accessed, or whether conventional access to the remainder objects in one or more second memory locations is requested. FIG. 1B illustrates access to the identified elements in the first memory location. Instructions 165 to load the base register are executed to place the FUD base address 186 in the base register 194. Offset register 195 is loaded with an offset computed to select a particular machine word within a first memory segment associated with the object being accessed and containing the element requested. Note that packing is optional, so the word requested may be the element or a portion of the element. Per access FUD word instructions 167, ALU 193 adds the base register 194 to the offset register 195 and makes a memory load request to fetch the machine word.

In this embodiment, a cache 191 is deployed, so the request is routed to the cache. As this is the first access, the object element will not be in the cache. The cache then fetches the element, along with a portion of its neighboring memory elements, shown as cache line 192, from memory 150. Alternatively, preload cache instructions 164 may have loaded these elements into the cache prior to their requested access by foo 163. In either case, in this illustration the entire set of N FUD elements resides in the cache 191, and so long as a cache miss does not cause their eviction, foo will have ready efficient access to the segregated identified elements for all the objects that fit in the cache. Whether on-demand based on cache pre-load or following the cache 191 load request to memory 150, the requested machine word is stored in FUD machine word register 196.

When the requested element is packed in the machine word, instructions 168 to isolate the element are executed. A shift and mask value is supplied to ALU 193a which applies the shift and mask to the machine word stored in FUD machine word register 196. In the instance in which scaling is to be applied to the isolated element due to storing the element in fewer bits than its defined size, the compiler will have generated instructions to apply the appropriate shift to accomplish the scaling. The resultant isolated and potentially scaled element is then supplied from ALU 193a to instructions 169 for further processing of the accessed element (details not shown). In this example, the isolate element instructions 168 include the appropriate shift and mask values in the instructions for supplying to ALU 193a. This is illustrative only; registers may also be used to store either a mask value or a shift value. In similar fashion, the output of the ALU 193a is supplied for use in the foo 163 function. However, that ALU output result may also be stored in a register, as dictated by the needs of the surrounding code, and thus enabled by the compiler. A variety of techniques for isolating as well as scaling packed values stored in a machine word are detailed in the aforementioned '037 application.

In this illustration, foo 163 loops through some number of iterations, potentially accessing additional packed elements stored in FUD machine word register 196. The base value in register 194 and the offset value in offset register 195 do not need to be updated while loading from or storing to elements in the machine word. When object to another machine word is required, instructions 170 determine access to the machine word in 196 is completed, and the process returns instructions 166 to load a new value into offset register 195 for accessing a new machine word, either another one associated with the current object, or one from another object. The appropriate offset will be determined via the auto-generated code from the compiler. The process continues until the end of foo 163 is reached, as determined by instructions 171.

This example illustrates the potential for keeping a relatively large number of frequently used elements in cache 191, avoiding cache misses which reduce performance. If an element from an object is requested that is stored in a second memory location, whether requested within foo 163, or in other code, the program instructions will load the base 194 and offset 195 registers for accessing the second memory location. In this example, the remainder elements for each of the objects are stored sequentially in memory location 180. The appropriate object remainder 188 is selectable via an object offset, which may be computed as an object index multiplied by the remainder object size. The element within the object can be identified by an element offset. An offset value to access is the sum of the two. That offset can be loaded in offset register 195 where ALU 193b adds it to the object base address 181 stored in base register 194. While the details of this conventional object accessing scheme are not detailed in FIG. 1B, note that compiler has automatically configured the program instructions to access the appropriate memory location during compilation. In this example, the element access request to cache 191 results in a cache miss. Cache 191 thus requests the element from memory 150. That retrieved element is then stored in remainder element register 197. The direct storage of an element from memory location 180 to register 197 as shown is simplified for illustration. A typical load/store scheme may fetch the element, along with other words, into a cache line 192 in cache 191 while supplying the result to register 197. Details of cache operation are omitted, such as loading remainder element into cache prior to/concurrent with storing in the register, or the interworking of additional cache levels.

At some point, delete D instructions may be encountered, and compiled instructions are executed to remove segmented object elements from both the first and second memory locations. The memory management structure set up to support a set of objects, such as DataType objects D, may be torn down as well. Details are omitted.

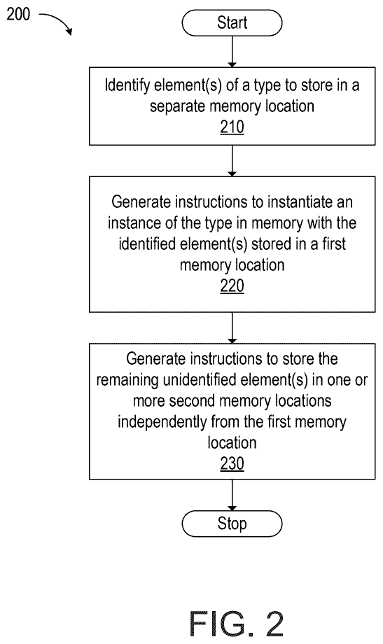

FIG. 2 is a flowchart 200 illustrating an example method of compiling source code for segregated-element object memory segmentation. One or more elements of the type are identified to store in a separate memory location, independent from the memory location or locations of remaining unidentified elements of the type (210). Upon identification of the elements, the compiler generates instructions to instantiate an instance of the type in memory and to store the identified elements in a first memory location (220). The compiler also generates instructions to store the remaining unidentified elements in one or more second memory locations independently from the first memory location (230).

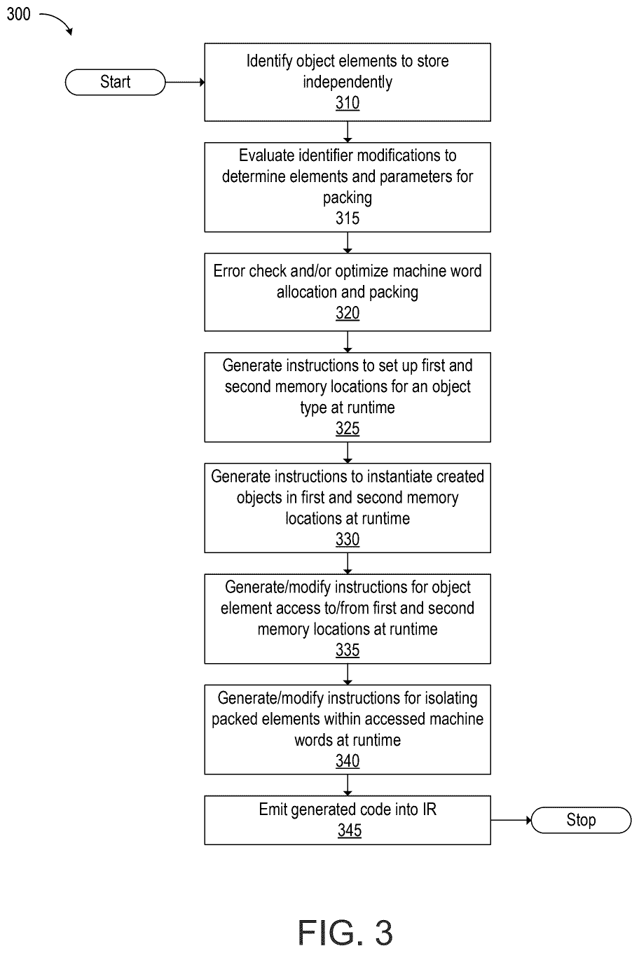

FIG. 3 is a flowchart 300 illustrating an example method of compiling source code using segregated-element object memory segmentation and element compression. For each type definition, the compiler determines which elements of an object are identified (if any) to be stored independently (310). Modifications to identifiers are evaluated to determine the elements and parameters for packing those elements into one or more machine words (315). Examples include positions, bit widths, element sizes, truncations, range restrictions, and the like.

Error check programmer specified modifications and optimize machine word allocation and packing (320). Various embodiments may employ one or more of these illustrative options. Machine word allocation (the number of machine words allocated for an object instantiation) may be determined as the minimum number to house the required elements, or alternatively optimized for another goal, such as eliminating or minimizing element overlap of two machine words. The compiler may evaluate source code and group certain elements in one of a plurality of allocated machine words when they are accessed together with high probability, and other such optimizations. Error checking may include ensuring that there not conflicting programmer directives (e.g. allocating a specific bit to more than one element. It may include warning when a directive unnecessarily places an element in more than the minimum required machine words. Embodiments may have the compiler generate a warning or an error. Alternatively, the compiler may fix an error or optimize packing by overriding a location specification, for example, by moving an element to a different location.

Generate instructions to set up the first and second memory locations for an object type utilizing memory segmentation at runtime (325). Generate instructions to instantiate created objects with the respective identified and unidentified elements in the first and second memory locations at runtime (330). Responsive to accesses to either segment of the instantiated object found in source code, generate or modify those access instructions for element access to or from respective first and second memory locations at runtime (335). Generate or modify instructions to isolate packed elements within accessed machine words at runtime, padding or scaling them as necessary (340). Emit the generated code into the IR for further compilation (345).

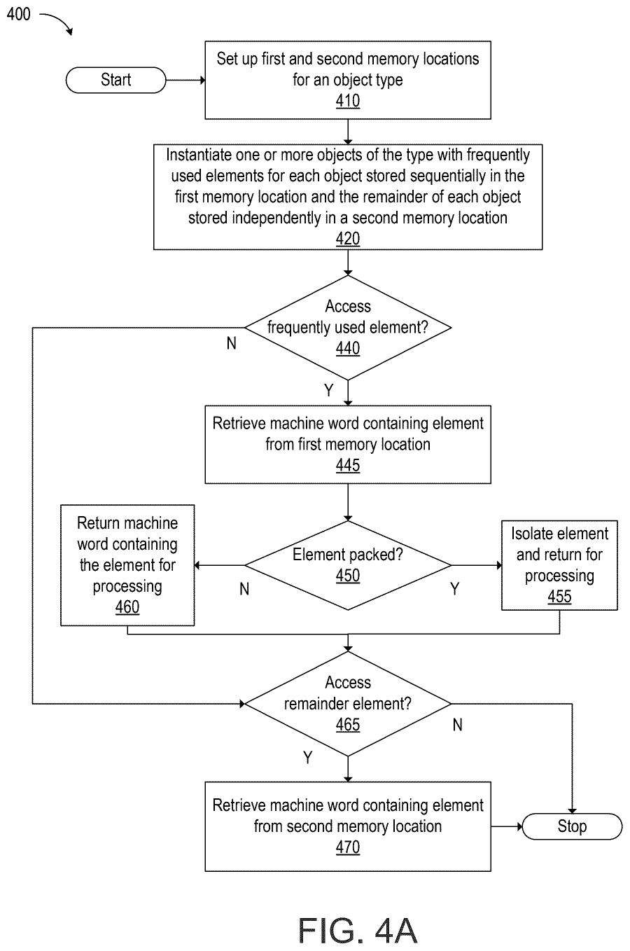

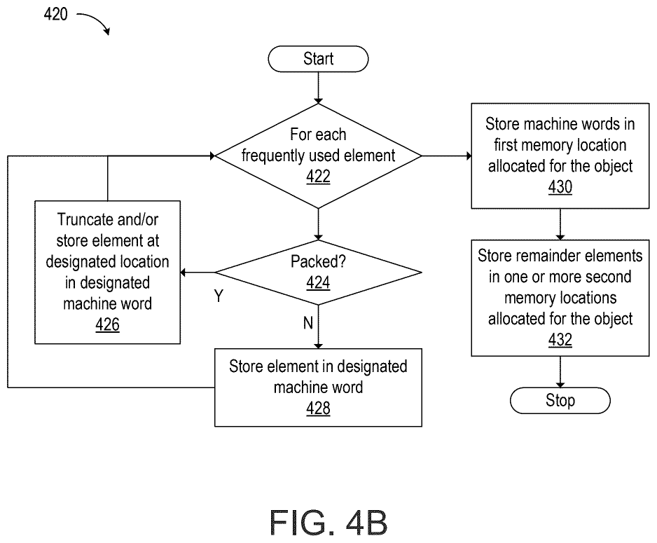

FIGS. 4A-B include a flowchart 400 illustrating segregated-element object memory segmentation and element compression operating at runtime. The first and second memory locations for an object type are set up within memory (410). Instantiate one or more objects of the type with frequently used elements for each object stored sequentially in the first memory location and the remainder of each object stored independently in a second memory location (420). Encounter an access to an element of the one of the objects. If it is a frequently used element (440), then retrieve the machine word containing the element from the first memory location (445). If the element is packed within the machine word (450), then isolate the element, scale or pad as necessary, and return the element for processing (455). Note that packing is not required for any element, even if other elements are packed in other machine words. For example, an element may use exactly the entire machine word, or the overhead for unpacking a particular element may not be desired. In either case, the instructions generated at compile time will perform the isolation (455) or return the machine word containing the element for processing (460), as appropriate. If the access was to a remainder (not an identified element as frequently used) (440 and 465), then retrieve the machine word containing the element from the second memory location (470).

An example embodiment of instantiating a segmented object (420) is detailed further in FIG. 4B. For each frequently used element in the object (422), if the element is packed (424), then store the element in its designated location (determined during compilation), truncated as appropriate, in the appropriate machine word (426). If it is not packed, store the element in the designated machine word (428). All the machine words are stored in the first memory location at the position allocated for the object (430). All the remainder elements are stored in one or more second memory locations that are allocated for the object (432).

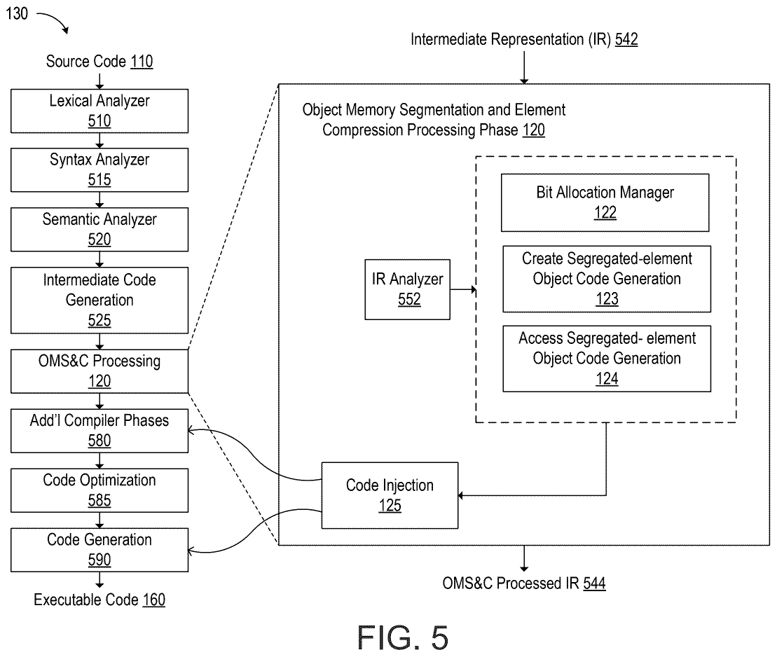

FIG. 5 is an example compiler 130 illustrating OMS&C processing phase 120. Lexical analyzer 510 performs lexical analysis, also known as scanning, where source code 110 is converted into a sequence of lexical units or tokens. Tokens are the smallest meaningful units of a programming language, such as keywords, identifiers, operators, and literals.

Syntax analyzer 515 performs syntax analysis, also known as parsing, where the compiler checks whether the sequence of tokens generated by the lexical analyzer 510 conforms to the rules defined by the programming language's grammar. This analysis typically involves constructing a parse tree or syntax tree (e.g. an AST) that represents the hierarchical structure of the source code.

Semantic analyzer 520 performs semantic analysis where the compiler examines the meaning of the statements and expressions in the source code beyond their syntactic structure. During semantic analysis, the compiler checks for semantic correctness, such as type compatibility, undeclared variables, and adherence to language-specific constraints. It also performs various optimizations and transformations based on the semantic properties of the code.

Intermediate code generation module 525 generates an intermediate representation (IR) 542 of the source code after semantic analysis and optimization, but before the final machine code. Often during intermediate code generation, the compiler translates high-level source code into an IR that is closer to the target machine language but still independent of the target machine architecture. This intermediate code is typically in the form of low-level instructions or an intermediate language. The main purpose of intermediate code generation is to provide a platform-independent representation of the source code that facilitates further optimization and simplifies the task of generating machine code for different target architectures. A variety of compiling processes may be applied to code in intermediate form. IR 542 may include one or more of any of a variety of forms, including but not necessarily a control flow graph, static single assignment, three-address code, intermediate representation language, an abstract syntax tree, and the like. IR 542 is an example of IR 140.

Code optimization module 585 is where the intermediate representation is improved to enhance its efficiency in terms of execution time, memory usage, or other performance metrics. During code optimization, the compiler applies various techniques and transformations to the intermediate code to eliminate redundant operations, minimize resource usage, and improve the overall quality of the generated code. Optimization techniques may include constant folding, dead code elimination, loop optimization, and many others. The primary goal of code optimization is to produce optimized code that executes more efficiently on the target platform, resulting in improved performance and reduced resource consumption. Other embodiments may employ different or additional compiler phases processing the IR for other purposes.

Code generation module 590 is where the optimized intermediate representation of the source code is translated into executable machine code specific to the target platform. During code generation, the compiler maps the instructions and constructs of the intermediate code to the corresponding machine instructions of and taking advantage of the specific features and optimizations offered by the target architecture. This involves generating assembly code or machine code that directly controls the behavior of the target hardware. Note that code generation may be carried out in multiple phases. For example, a low-level language such as c/llvm may be an intermediate target of code generation 590. An intermediate level compilation can be further processed into executable code 160 for one or more target processors and/or architectures.

In this embodiment, The OMS&C processing phase 120 operates on IR 542 to produce OMS&C Processed IR 544, which is used in additional compiler phases 580 and leading to code optimization and code generation. The generated code can be compiled along with other code in the IR or can be injected into the executable during code generation 590, or a combination of both, as indicated in FIG. 5. The description herein for support in a compiler for OMS&C processing phase 120 is provided illustratively. It will be appreciated that compiler support may be implemented in similar ways over various phases and passes of compilation, using the principles described herein.

The generated instructions may be converted in whole or in part into a machine code format. Instructions can also be maintained in IR format. The Code Injector 125 receives generated machine code and inserts it into the appropriate location within the final executable during code generation 590. Generated instructions remaining in IR format are injected to IR 544 for further processing in additional compiler phases 580, and any subsequent processing. The Code Generation 590 ensures that machine code is optimized and compatible with the target system. This process can involve converting the instructions into binary code or bytecode, which is then translated into machine code. Instructions maintained in IR format can be further processed by the compiler.

Example 1 illustrates an employee type for which a subset of its elements are identified using the identifier construct “frequently_used_bit” for packing into machine words and storing in the first memory location.

| | |
|---|---|
| 1 | employee := type |
| 2 | name := string |
| 3 | emp_id := unique(number) |
| 4 | male? := boolean |
| 5 | age := u8(number) |
| 6 | basic_pay := number |
| 7 | promotion_candidate? := boolean |
| 8 | ?reason_for_non_promotion := string |
| 9 | leadership_role? := boolean |
| 10 | number_of_projects_completed := number |
| 11 | connect_id := unique(number) |
| 12 | reportee := string |
| 13 | ?reporting_to := string |
| 14 | number_of_sick_leave := number |
| 15 | number_of_casual_leave := number |
| 16 | number_of_loss_of_pay := number |
| 17 | on_site? := boolean |
| 18 | |
| 19 | ..employee -- path to employee type |
| 20 | frequently_used_bit [4..19] : emp_id |
| 21 | frequently_used_bit [2] : male? |
| 22 | frequently_used_bit [21..27] : age |
| 23 | frequently_used_bit [25] : leadership_role? |
| 24 | frequently_used_bit [_] : connect_id |
| 25 | frequently_used_bit [_] : number_of_casual_leave(.bit_width : 4) |
| 26 | |
| 27 | |
| 28 | +e1 = employee(name : create.get(“e1_name”), emp_id : create.get(“e1_emp_id”), |
| | male : .get(“e1_male”), age : create.get(“e1_age”), basic_pay : create.get(“e1_basic_pay”), |
| | promotion_candidate : create.get(“e1_promotion_candidate”), reason_for_non_promotion : |
| | create.get(“e1_reason_for_non_promotion”), leadership_role : create.get(“e1_leadership_role”), |
| | number_of_projects_completed : create.get(“e1_number_of_projects_completed”), connect_id : |
| | create.get(“e1_connect_id”), reportee : create.get(“e1_reportee”), reporting_to := |
| | create.get(“e1_reporting_to”), number_of_sick_leave : create.get(“e1_number_of_sick_leave”), |
| | number_of_casual_leave : create.get(“e1_number_of_casual_leave ”), number_of_loss_of_pay : |
| | create.get(“e1_number_of_loss_of_pay”), on_site : create.get(“e1_on_site”) ) |
| 29 | |
| 30 | print (e1.emp_id) |
| 31 | print (e1.name) |

### Example 1. Pseudocode for Illustrating Identifying and Packing a Subset of Elements of a Type

In Example 1, line 1 defines an employee type with its elements defined in lines 2 to 17. The programmer can identify one or more elements of the employee type to store in a separate memory location. Here, in lines 19 to 25 the programmer has identified some of the elements of the employee type to pack in machine words and store separately using the identifier construct “frequently_used_data”. The identifier constructs in lines 20 to 23 include bit locations to store the elements within one or more machine words. The constructs in lines 24-25 do not specify a bit location, leaving that decision to the compiler. The construct in line 25 specifies a bit width for an element which differs from its defined width, in this case directing the compiler to compress the element when packing into the machine word. In Example 1, the elements emp_id, male?, age, leadership_role?, connect_id and number_of casual_leave are identified by the programmer in lines 20 to 25 to pack and store in a separate memory location.

Line 19 indicates the path to the employee type whose elements are identified by the programmer for packing and storing. The identifier construct in line 20 indicates that the element emp_id is identified and it is to be packed at the location ranging from bit number 4 to bit number 19 in the machine word or words. Similarly, line 21 indicates that the element male? is to be packed at bit number 2. Further, lines 22 and 23 indicate that age is to be packed at the location ranging from bit number 21 to 27 and leadership_role? is to be packed at bit number 25. Note here that this provides a conflict, which may be resolved in a variety of different ways in different embodiments. Line 24 indicates that the element connect_id is identified by the programmer using the indicator construct but there is no specific bit location provided. In line 25, the element number_of_casual_leave is identified by the programmer indicating a bit width of 4. This specified bit width indicates the number of bits in which the element number_of_casual_leave is stored within the machine word.

Line 28 is an instruction to create an instance e1 of the type employee and initialize all its elements. During compilation, the compiler will generate instructions to create the instance e1 at run time. The compiler will generate instructions to store the identified elements in a separate memory location and also generates instruction to store the remaining unidentified elements in a memory location independent from the memory location of the identified elements. The compiler generates instructions to pack the identified elements at appropriate bit locations in the machine words.

Line 30 is an instruction to print the element emp_id of the instance e1 which is an identified element. During compilation, the compiler will generate instructions to isolate the element emp_id from the machine word(s) stored in the segregated memory location using an appropriate mask and print it. Similarly, line 31 is an instruction to print the element name of the instance e1 which is not identified by the programmer for storing in a separate memory location. During compilation, the compiler will generate appropriate instructions to print the element name from the memory location where the remaining unidentified elements are stored.

It is to be noted that in line 5 of Example 1, age is defined to occupy 8 bits in the memory. However, in line 22, the programmer has specified to pack the element age within 7 bits in the machine word. The programmer may have used a smaller range of values for age, as 128 years may be a suitable upper limit in an application. In other applications, the programmer may desire to substitute precision for storage space. In that case, the element may have less significant bits truncated, as illustrated earlier. A combination of range restriction and truncation may be employed. The compiler will generate instructions to access elements whose range is limited or truncated by the programmer which retrieve the machine word, isolating the element, and padding or scaling as necessary before supplying it for execution.

In one embodiment, the number of machine words allocated to pack the identified elements for a type is determined based on their total size, and particular bit locations specified. The total number of bits required is calculated by the compiler, which computes the required number of bits to store the elements based on the specified bit locations and the size of the elements (which may optionally be modified by a specified bit width, as discussed above). In Example 1, line 20 indicates that emp_id occupies the range 4 to 19 which will require 16 bits. Line 22 specifies a location range from 21 to 27, indicating that 7 bits are used to pack the age. Line 21 and line 23 indicate that the number of bits used is only one per element for male? and leadership_role?. At line 25, the element number_of_casual_leave is indicated to occupy 4 bits. Hence, the total number of bits as specified by the programmer is 16+7+1+1+4=29. The programmer has not specified any bit locations for the element connect_id in line 24. Here, the compiler tracks the data type of the element connect_id from line 11, which is a number, defined to be 16 bits in this embodiment. and hence the total number of bits required is 45.

For this illustration, consider an example embodiment having a machine word comprising 32 bits. Therefore, to pack the entire set of identified elements, 2 machine words (64 bits) are allocated. The elements identified by the programmer are packed within these 64 bits at the programmer specified bit locations. It is to be noted that within the 64 bits of the machine words, the bit locations 1, 3, and 20 are not assigned to any of the identified elements for packing by the programmer as per example 1. Those bits are interleaved unassigned bits. In such cases, the compiler can optionally analyze the code to find additional elements for packing that are not identified by the programmer and pack them in those unassigned bit locations. In this case, say based on the analysis of the code, the compiler finds that the element of the employee type promotion_candidate? is a suitable element to pack and store in a separate memory location, such as bit location 1. Similarly, bit number 3 and 20 can also be packed with compiler-identified elements. If no suitable element is identified by the compiler, then those bits may be padded.

In the case of leadership_role? element, there is an overlap in the bit allocation with that of the bit range of the element age. The element leadership_role? is assigned with bit location 25, which is already covered by the bit location range of age from 21 to 27. In such scenarios, the compiler handles the overlap by providing a compiler generated message to the programmer. Alternatively, the compiler may move elements to remove the overlap. For example, in this example, the leadership_role? element is moved to the interleaved unassigned location at bit number 3. The number_of _casual_leave is provided with number of bits to be used as 4. Therefore, the compiler will decide on the location in the machine words to pack number_of_casual_leave element. Here, it is packed at the location starting from 28 to 31 after packing the other elements at the programmer specified locations. For the element connect_id there is no specific bit location provided by the programmer and hence the compiler can automatically pack that element after the bit location of number_of_casual_leave element.

While packing the elements into the machine words, if any of the element extend more than one machine word, the compiler can handle it in different ways. In one embodiment the element location can be modified by the compiler to pack within a single machine word. In another embodiment the compiler can pack the element in more than one machine word by splitting the element. In yet another embodiment, the compiler can generate a compile time message to the programmer to resolve this. In each embodiment, having resolved any conflicts, the compiler will automatically generate instructions to fetch each element appropriately responsive to an access.

The compiler can decide the appropriate location based on element access efficiency. For example, connect_id requires 16 bits to pack. If connect_id is packed at the bit location range from 32 to 47, the element would be split across two machine words: bit 32 in the first machine word and 33 to 47 in the second. Instead, the compiler packs connect_id in a location starting from 33 to 48 in the second machine word. In so doing, connect_id can be accessed at runtime by fetching the second machine word alone. If the compiler, based on its analysis of the code, finds that a few of the elements are likely to be accessed together then those elements can packed together in the same machine word. Say, for example, if the compiler finds that emp_id and connect_id are mostly accessed together, it can pack connect_id and emp_id in a single machine word so that when these elements are accessed only one machine word is fetched and the remaining elements can be packed at appropriate locations in a different machine word. Nonetheless, for the current illustration, connect_id is packed at the bit locations 33 to 48, leaving bits 20, 32 and 49 to 64 (a total of 18 bits) unallocated. These unallocated bit locations can be used to pack additional compiler-identified elements. If no suitable element is identified by the compiler, then these bits can be padded.

A compiler, examples of which are described above, is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The prior discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art.

FIG. 6 illustrates an example embodiment of distributed Integrated Development Environment (IDE) 600 including components of a computational device, or user terminal, 100. Here user terminal 100 is connected via network 640 with other user terminals 100a-n and a project server 650. However, it should be noted that an IDE operating environment, a computational device 100, and the aspects disclosed herein are not constrained to any particular configuration of devices.

User terminals 100 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IOT) device, a distributed computing system, multiprocessor systems, or combination thereof. A user terminal may be configured utilizing a cloud service. The operating environment of IDE 600 may be configured in a network environment, a distributed environment, a multi-processor environment, or a stand-alone computing device having access to remote or local storage devices.

User terminals 100 may include one or more processors 610, a communication interface 612, one or more storage devices 616, one or more input/output devices 618, and a memory 150. A processor 610 may be any commercially available or customized processor and may include multi-processor architectures. The communication interface 612 facilitates wired or wireless communications between the computing devices such as user terminals 100, project server 650, and other devices. The components of a user terminal 100 are communicatively coupled via one or more buses 614.

A storage device 616 may be a computer-readable medium that does not contain propagating signals, such as modulated data signals transmitted through a carrier wave. Examples of a storage device 616 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 616 in the computing devices 100. The input/output devices 618 may include a keyboard, mouse, pen, voice input device, touch input device, display, speakers, printers, etc., and any combination thereof.

A memory 150 may be any non-transitory computer-readable storage media that may store executable procedures, applications, and data. Various of these components and data are detailed above with respect to FIGS. 1 and 5. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc.. A memory 150 may also include one or more external storage devices or remotely located storage devices.

The memory 150 may contain instructions, components, and data. A component is a software program that performs a specific function and is otherwise known as a module, program, and/or application. The memory 150 may include an operating system 630, one or more source code files 110, a compiler 130, executable code 160, and other applications and data 636. Compiler 130 may include a lexical analyzer 510, a syntax analyzer 515, a semantic analyzer 520, an intermediate code generation module 525, a code optimization module 585, a code generation module 590, an Object Memory Segregation and Compression (OMS&C) processing module 120, and an intermediate representation 140.

User terminal 100 may utilize an IDE (details not shown) that allows a user (e.g., developer, programmer, designer, coder, etc.) to design, code, compile, test, run, edit, debug, or build a program, set of programs, web sites, web applications, and web services in a computer system. Software programs can include source code files 110, created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like, as well as proprietary or custom-designed programming languages). The IDE may provide a native code development environment or may provide a managed code development that runs on a virtual machine or may provide a combination thereof. The IDE may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

Project server 650 may be any type of electronic device, including without limitation those detailed for user terminals 100. A project server may be configured utilizing a cloud service.

The user terminals 100 and project server 650 may be communicatively coupled via network 640. The network 640 may be configured as an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Network (MAN), the Internet, a portion of the Public Switched Telephone Network (PSTN), Plain Old Telephone Service (POTS) network, a wireless network, a WiFi® network, or any other type of network or combination of networks.

The network 640 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A non-transitory computer-readable medium having stored thereon a source code compilable by a compiler and executable by a processor coupled with a memory, the source code comprising:
a type definition defining a type comprising a plurality of elements; and
an identifier construct identifying at least one of the plurality of elements for storing independently from the remainder of the plurality of elements in a first memory location in the memory, the first memory location independent from one or more second memory locations in the memory in which the remainder of the plurality of elements are stored.

2. The medium of claim 1, wherein the identifier construct signals the compiler to generate instructions that compile to execute at runtime, the instructions operable to instantiate a plurality of objects of the type in the memory, wherein the at least one of the plurality of elements identified by the identifier construct of each of the plurality of objects are stored in a plurality of first memory locations, and the remainder of the plurality of elements of each of the plurality of objects are stored in a plurality of second memory locations, the first memory location associated with each object independent from the one or more second memory locations of that object.

3. The medium of claim 1, wherein the source code further comprises a second identifier construct identifying a second at least one of the plurality of elements for storing in the first memory location in the memory, with the first-mentioned at least one element identified by the first-mentioned identifier construct, independently from the remainder of the plurality of elements, the remainder of the plurality of elements stored in the one or more second memory locations.

4. The medium of claim 1, wherein the identifier construct is modified to indicate a storing location in the first memory location.

5. The medium of claim 4, wherein the storing location is a range of bit values indicating a bit width and associated bit positions.

6. The medium of claim 1, having further stored thereon a configuration file readable by the compiler, and wherein the identifier construct is contained within the configuration file.

7. A method, operable with source code comprising a type definition defining a type comprising a plurality of elements, the method comprising:
identifying at least one of the plurality of elements for storing independently from the remainder of the plurality of elements;
generating instructions to instantiate an instance of the type in a memory with the at least one or more identified elements stored in the memory at a first memory location and the remainder of the plurality of elements stored in the memory at one or more second locations, the first memory location independent from the one or more second memory locations in which the remainder of the plurality of elements are stored.

8. The method of claim 7, wherein the identified at least one of the plurality of elements includes a first identified element and a second identified element, the method further comprising generating instructions to store the first and second identified elements in a machine word in the memory at the first memory location.

9. The method of claim 7, wherein identifying elements for storing independently is performed by compiler analysis of access to the plurality of elements in source code, and an identified element is selected from the plurality of elements responsive to the analysis suggesting the element is accessed with a higher frequency relative to a non-selected element of the plurality of elements.

10. The method of claim 7, wherein identifying elements for storing independently comprises encountering an identifier construct identifying one of the plurality of elements for storing independently.

11. The method of claim 10, further comprising, responsive to the identifier construct being modified to specify a storing size less than the size of the identified element as defined, generating instructions for storing and retrieving the identified element with the reduced number of bits according to the specified storing size.

12. The method of claim 10, wherein the identifier construct indicates that the element is frequently used data.

13. The method of claim 10, wherein the identifier construct indicates that the element is to be compressed.

14. The method of claim 10, further comprising generating instructions to pre-fetch the element for loading into a cache.

15. The method of claim 10, further comprising, responsive to the identifier construct being modified, determining an element location in accordance with the construct modification within the first memory location in which the identified one of the plurality of elements is to be stored.

16. The method of claim 15, further comprising:
encountering one or more second identifier constructs each identifying one of one or more second elements for storing in the first memory location and indicating a stored size for the one of the one or more second identified elements; and
determining the first-mentioned element location in accordance with the stored size of each of the second one or more identified elements.

17. The method of claim 10, further comprising, responsive to the identifier construct being modified, determining the number of bits within a machine word in the first memory location in accordance with the construct modification in which the identified one of the plurality of elements is to be stored.

18. The method of claim 10, wherein the identifier construct is modified to indicate a bit width of the element for storing in the first memory location, the method further comprising determining the associated bit positions for the stored element of the bit width.

19. The method of claim 7, wherein:
the source code comprises a plurality of identifier constructs identifying a plurality of elements for storing in the first memory location, the plurality of identifier constructs indicating a stored size for each of the plurality of identified elements, the stored size of an element being less than or equal to the size of the element as defined; and
identifying elements for storing independently comprises encountering the plurality of identifier constructs identifying the plurality of elements for storing in the first memory location;
the method further comprising:
determining a number of machine words required to accommodate storing each of the elements identified for storing independently according to each element's respective stored size;
allocating the number of machine words for including in the first memory location; and
storing the elements identified for storing independently in the number of machine words included in the first memory location.

20. A system comprising:
one or more processors coupled to a memory; and
one or more programs, wherein the one or more programs are stored in the memory and configured to be executed by the one or more processors, the one or more programs including program instructions that:
instantiate in the memory a plurality of objects, each object having a plurality of object elements including at least one first element and at least one second element;
for each of the plurality of objects, store the at least one first element into a respective first memory segment for the object;
store each of the first memory segments of the plurality of objects contiguously starting at a first memory location; and
store each of the at least one second element of each of the plurality of objects at one of a plurality of second memory locations, each second memory associated with an object independent of the first memory location for that object.

21. The system of claim 20, wherein the one or more programs further include program instructions to access one of the at least one first elements of a first of the plurality of objects that:
retrieve a machine word contained in the first memory segment associated with the first object, the retrieved machine word containing the one first element; and
extract the one first element from the retrieved machine word.

22. The system of claim 20, further comprising a cache having a set of cache lines, each cache line, responsive to a memory access, storing a bank of contiguous memory associated with the memory access, wherein, responsive to an access to a first memory segment of a first object, the cache stores the first memory segment of the first object and the contiguously stored first memory segment of a second object in a first of the set of cache lines.
